(19) United States
(12) Patent Application Publication
(10) Pub. No.: US 2013/0103574 A1
(43) Pub. Date: Apr. 25, 2013

(54) Payment Delegation Transaction Processing

(71) Applicants: Abbe Elizabeth Conrad, Atlanta, GA (US); Francis J. Pavlik, Dunwoody, GA (US); Scott Christopher Francis, Atlanta, GA (US)

(72) Inventors: Abbe Elizabeth Conrad, Atlanta, GA (US); Francis J. Pavlik, Dunwoody, GA (US); Scott Christopher Francis, Atlanta, GA (US)

(73) Assignee: FIRST DATA CORPORATION, Greenwood Village, CO (US)

(21) Appl. No.: 13/276,574

(22) Filed: Oct. 19, 2011

(51) Int. Cl. G06Q 20/08; G06Q 20/20

(52) U.S. Cl. 705/39

(57) ABSTRACT

Systems, methods, and computer-readable media for processing payment delegate transactions are provided. A transaction message associated with a payment instrument of a customer may be received by a payment processing service from a merchant. The payment processing service may determine when the payment instrument is not a payment delegate. When the payment instrument is not a payment delegate, the payment processing service may communicate a response to the merchant processor. When the payment instrument is a payment delegate, a message may be communicated to a funding source gateway and/or an indication that the payment instrument is a payment delegate may be communicated to at least one memory.

### FIELD OF THE DISCLOSURE

Aspects of the disclosure relate generally to processing virtual wallet transactions, such as from a mobile device, and more particularly, to systems, methods, and computer-readable media for processing transactions of virtual wallets utilizing payment delegates.

### BACKGROUND

Mobile devices, such as cell phones, personal digital assistants (“PDAs”), smart phones, and other similar devices, have increasingly been utilized to provide additional functionality beyond traditional voice communications. One component of enabling the mobile devices to support these additional functionalities includes installing software applications on the mobile devices. Mobile device applications can facilitate a variety of services performed by or with the mobile devices, including payment applications (e.g., prepaid, credit, debit, etc.), loyalty or incentive applications, transportation payment applications, access control applications, entertainment applications, and the like. Additionally, service providers operating services associated with these applications, for example payment services, need to be able to interact with their customers regardless of the type of payment instrument used.

### BRIEF DESCRIPTION

Some or all of the above needs and/or problems may be addressed by certain aspects of the disclosure. Aspects of the disclosure may include systems, methods, and computer-readable media for processing payment transactions. In one embodiment, a method may be provided. A transaction message associated with a payment instrument of a customer may be received from a merchant processor. Whether the payment instrument is a payment delegate may be determined. Additionally, when the payment instrument is not a payment delegate, a response may be communicated to the merchant processor. Further, when the payment instrument is a payment delegate, a message may be communicated to a funding source gateway and/or an indication that the payment instrument is a payment delegate may be communicated to at least one memory.

In another embodiment, a system may be provided. The system may include at least one communication interface, at least one processor, and at least one memory. The system may also include computer-executable instructions and may be configured to receive an indication that a customer has enrolled a funding source with a payment instrument. The system may also be configured to receive a pre-authorization message associated with the payment instrument of the customer, determine when the payment instrument is a payment delegate, communicate a response to the merchant processor when the payment instrument is not a payment delegate, and when the payment instrument is a payment delegate, communicate a pre-authorization request to a funding source gateway for approval of funds from a funding source.

In yet another embodiment, a computer-readable media comprising instructions for processing virtual wallet transactions may be provided. An indication that a customer has enrolled a funding source with a payment instrument may be received. A settlement message associated with the payment instrument of the customer may be received. It may then be determined whether the payment instrument is a payment delegate. Additionally, a response to the merchant processor may be communicated if the payment instrument is not a payment delegate. Further, a settlement may be recorded in a log associated with the funding source or funds may be loaded to an online account if the payment instrument is a payment delegate.

Additional systems, methods, computer-readable media, features, and aspects may be realized through the techniques of various embodiments of the disclosure. Other embodiments and aspects of the disclosure are described in detail herein with reference to the description and to the drawings and are considered a part of the claimed disclosure.

### BRIEF DESCRIPTION OF THE DRAWINGS

Reference will now be made to the accompanying drawings, which are not necessarily drawn to scale, and wherein:

FIG. 1 illustrates a block diagram of one example system that may be utilized to facilitate processing payment transactions, according to an illustrative embodiment of the disclosure.

FIG. 2 illustrates a flow diagram of one example method that may be performed for processing payment transactions, according to an example embodiment of the disclosure.

FIG. 3 illustrates a flow diagram of an example method for processing a pre-authorization message, according to an example embodiment of the disclosure.

FIG. 4 illustrates a flow diagram of an example method for processing a settlement message, according to an example embodiment of the disclosure.

FIG. 5 illustrates a flow diagram of an example method for processing a forced post message, according to an example embodiment of the disclosure.

FIG. 6 illustrates a flow diagram of an example method for processing a return message, according to an example embodiment of the disclosure.

### DETAILED DESCRIPTION

### Overview

Embodiments of the present disclosure are directed to, among other things, systems, methods, and computer-readable media for processing payment transactions, including virtual wallet transactions and/or transactions that involve payment delegates as payment instruments. As used herein, a payment delegate may refer to any type of form factor, such as a debit card, prepaid debit card, virtual wallet, mobile device, rewards card, payment instrument, or the like, that may be linked to a payment instrument, such as but not limited to a credit or debit card of a user, a bank account of a user, a rewards account of a user, a generic funding source, or the like. Additionally, a payment delegate may include any method or system for linking a form factor, or the like to a any type or combination of payment instruments. As an overview, users (i.e., customers) of a payment processing service may register a payment instrument, such as a credit card for use with a virtual wallet. In some instances, the virtual wallet may be accessed via and/or stored on a mobile device, such as a smart phone, a tablet personal computer (“PC”), a PDA, or the like. Additionally, in some aspects, the payment processing service may act as, or be implemented by, a trusted service manager (“TSM”) for receiving and processing transactions between a user and one or more merchants (or merchant computers). However, in other aspects, the payment processing service may be separate and distinct from the TSM.

In some instances, the payment processing service and/or TSM may receive messages from the merchant computer or the mobile device of the user indicating that a type of transaction is being requested. By way of example only, transaction types may include pre-authorization requests, settlement requests, force posts, and/or returns. For example, a user may visit an online or brick-and-mortar store of a merchant and may request to purchase an item. The merchant, or a computer associated with the merchant, such as, but not limited to, a point of sale (“POS”) device my send a pre-authorization message to the payment processing service and/or TSM to verify that the user has sufficient funds in a payment account to purchase the item. The payment processing service and/or TSM may then process the pre-authorization request and provide a response to the merchant computer indicating whether or not the user has sufficient funds to purchase the item. Additionally, the payment processing service and/or TSM may be in communication with a funding account gateway, such as a card-not-present credit card gateway, or the like. In some instances, the funding source gateway may be able to provide pre-authorization responses on behalf of the registered payment instrument of the user. In other words, the payment processing service and/or TSM may rely on the funding source gateway to determine whether or not a user is pre-authorized to make the purchase and/or to settle payments by providing funds to a payment delegate. Additionally, in some aspects, a token may be provided to a mobile device by the payment processing service. This token may be validated by the merchant, indicating that the mobile device has access to any number or type of payment accounts.

As desired, various embodiments of the disclosure may utilize payment processing service and/or TSM functionality to facilitate integration between multiple service providers and multiple mobile devices operating on any number of carrier networks, each operated, in some examples, by a different mobile network operator (“MNO”). In certain embodiments, a payment processing service and/or TSM may be a third party entity strategically positioned to provide mobile device application provisioning services and/or integration functionality for provisioning mobile device applications and associated end user data to end users' mobile devices, to provide mobile device application-related lifecycle management services, to manage many-to-many relationships between the multiple service providers and the MNOs operating the carrier networks, and/or to process the various types of transaction messages provided by virtual wallets and/or merchants.

In some examples, applications that can be provisioned on mobile devices via a TSM can be any software application provided by a service provider or other application provider and/or any software application operable with a mobile device. According to one embodiment, near field communication (“NFC”) applications that enable subsequent transactions using NFC technology of the mobile device (e.g., radio frequency identification (“RFID”) are among those mobile device applications provided by service providers. However, as used herein, mobile device applications are not limited to NFC-based applications. Example mobile device applications may include, but are not limited to, open loop and closed loop payment applications (e.g., MasterCard® PayPass™, Visa payWave™, American Express® ExpressPay, Discover® ZIP, NXP Mifare®, etc.), transit payment applications, loyalty applications, membership applications, electronic promotion and incentive applications, ticketing applications, access control and security applications, entertainment applications, retail shopping applications, and the like.

In addition to providing integration and mobile device application provisioning functionality, a payment processing service and/or TSM may be further operable to provide additional features and functionality associated with each application provisioned and with each service provider, MNO, and/or mobile device end-user relationship. Example additional features that a payment processing service and/or TSM may provide include, but are not limited to, application lifecycle management (e.g., load, personalize, lock, unlock, terminate, etc.), secure element lifecycle management (e.g., lock, unlock, terminate, etc.), workflow management (e.g., new handset, exchanged handset, damaged handset, lost handset, stolen handset, closed MNO account, closed service provider account, etc.), secure element data preparation and application personalization, MNO customer service, service provider customer service, over the air (“OTA”) provisioning, secured key management, end user authentication, MNO-based end user registration, carrier network-based end user registration, service provider-based end user registration, interactive voice response-based (“IVR-based”) end user registration, live end user registration, payment processing, and the like. It is appreciated that the aforementioned additional payment processing service and/or TSM features and functionality are provided for illustrative purposes only, and that any number of features and functionality may be provided by the payment processing service and/or TSM to service providers, MNOs, and/or end users in association with the virtual wallet transaction processing and functionality.

Embodiments of the disclosure will now be described more fully hereinafter with reference to the accompanying drawings, in which embodiments of the disclosure are shown. This disclosure may, however, be embodied in many different forms and should not be construed as limited to the examples set forth herein; rather, these embodiments are provided so that this disclosure will be thorough and complete, and will fully convey the scope of the invention to those skilled in the art. Like numbers refer to like elements throughout.

### Illustrative Architecture

Embodiments of the disclosure will now be described more fully hereinafter with reference to the accompanying drawings, in which embodiments of the disclosure are shown. This disclosure may, however, be embodied in many different forms and should not be construed as limited to the examples set forth herein; rather, these embodiments are provided so that this disclosure will be thorough and complete, and will fully convey the scope of the invention to those skilled in the art. Like numbers refer to like elements throughout.

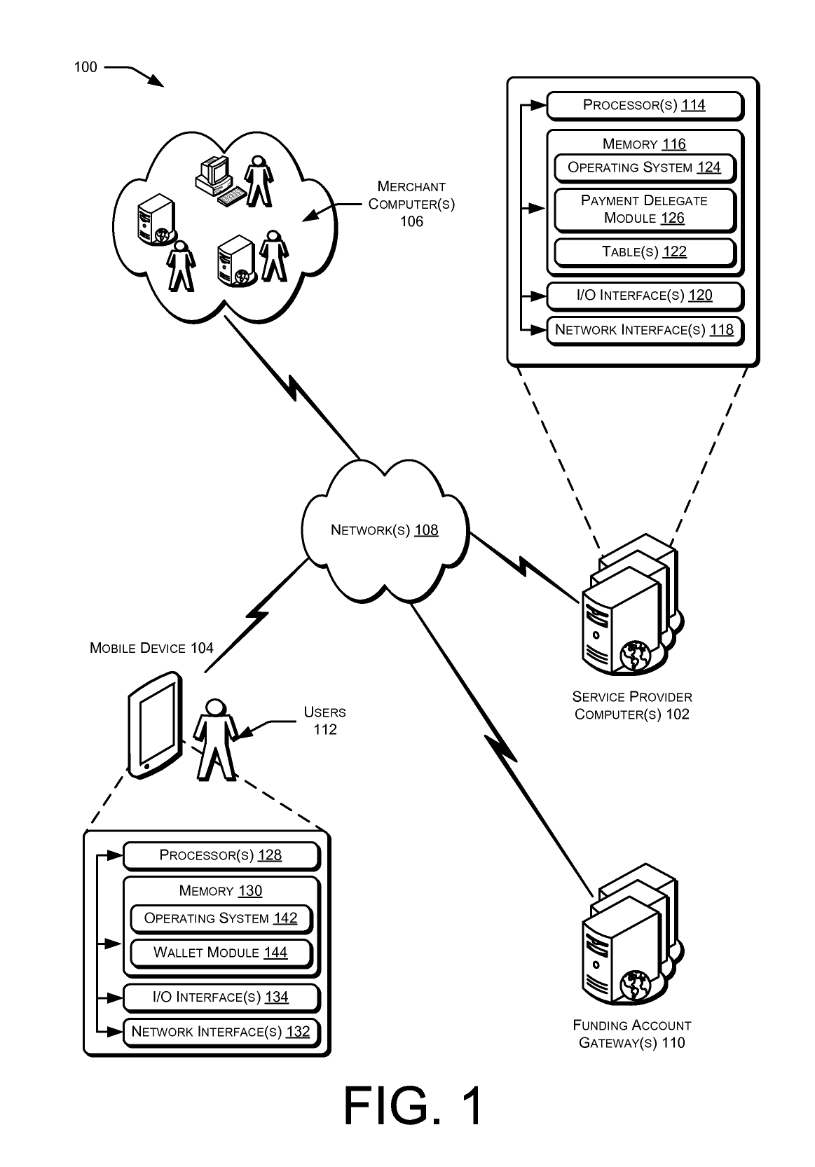

FIG. 1 depicts an illustrative architecture 100 in which techniques for processing transactions, including but not limited to virtual wallet transactions, may be implemented. In architecture 100, payment processing service and/or TSM functionality may be provided by one or more service provider computers 102. In some examples, the service provider computer 102 may be configured to process virtual wallet transactions attempted between one or more mobile devices 104 and one or more merchant computers 106, where either or both are accessible over one or more networks 108, such as the Internet. Additionally, the service provider computers 102 and/or one or more funding account gateways 110 may also be accessible over the one or more networks 108.

In some examples, one or more users 112 may utilize the one or more mobile devices 104 for implementing virtual wallet applications stored thereon, or stored elsewhere. For example, in some examples, the virtual wallet application may be stored on and/or implemented by the mobile devices 104. However, in other instances, such applications may be implemented by a service provider computer 102, such as a payment processing service and/or TSM, or by another server accessible by the mobile devices 104 over the one or more networks 108. Further, in some instances, virtual wallet information, such as but not limited to a user's 112 account information, payment information, billing information, etc., may be stored within a secure element of the mobile device 104. However, in other instances, the virtual wallet information may be stored at the payment processing service and/or TSM or other service provider computer 102 and merely accessed by the mobile devices 104.

In one non-limiting example, a user 112 may attempt to purchase one or more items from a merchant, utilizing one or more computers, such as the merchant computers 106. The purchase, or attempt to purchase, may include an online purchase or an in-store purchase such as at a physical brick-and-mortar location. Either way, the merchant computers 106 and/or the mobile device 104 may attempt to pre-authorize the transaction. In this way, the merchant computer 106 may be notified that the user 112 has sufficient funds, either in the form of a positive funds balance, credit balance, rewards balance, or a combination thereof. In this example, the service provider computer 102 may process the pre-authorization request including, but not limited to, transmitting the pre-authorization request to a third-party processor, such as the funding account gateway 110. Additionally, the service provider computer 102 may also provide a pre-authorization response to the merchant computer 106.

In some aspects, a merchant associated with the one or more merchant computers 106 may wish to a settle a transaction with a payment instrument associated with a user 112, with a payment delegate associated with the user 112, or with a combination of both. In this case, the merchant computer 106 may send a settlement request to the service provider computer 102 for processing. Further, as desired, the settlement may include payment by a credit card, a debit card, a bank account, a form factor, a virtual wallet, a rewards account or any combination thereof. For example, a settlement may include partial payment by a registered bank account and partial payment by a rewards points balance associated with the user 112. In other aspects, a forced post transaction message may be processed by the service provider computer 102 for the merchant computer 106. In some instances, a forced post may include forcing a settlement, or transfer of funds to an account of the merchant without first determining if sufficient funds exist in an account of the user 112. In this case, it is possible that no pre-authorization is performed by the payment processing service, TSM, and/or service provider computer 102. Still, a forced-post response may be sent by the service provider computer 102 to the merchant computer 106. Further, in some aspects, the payment processing service, TSM, and/or service provider computer 102 may process a return for a customer 112. In this example, the service provider computer 102 may receive the return transaction from the merchant computer 106, process the transaction, and provide a response message to the merchant computers 106.

Additionally, as noted above, a user 112 may register a credit card, debit card, rewards account, or other generic funding source for use with the virtual wallet application. In some instances, this funding account may be linked with a pre-paid account, a debit account, a rewards account, or the like. In this way, a payment delegate may be created for use via the virtual wallet application. For example, a mobile device 104 or other PC of the user 112 may include a user interface (“UI”) that allows a user to create, update, and/or remove a user account, update user information, register payment accounts, and the like. With reference to the UI, the user 112 may also activate the virtual wallet to initiate the processing of transactions with the service provider computer 102. Further, in some instances, the service provider computer 102 may determine whether the transaction request is associated with a payment delegate of a user 112.

The service provider computer 102 of FIG. 1 (e.g., a payment processing service and/or TSM computer) may be any suitable processor-driven device that facilitates the receipt, processing, and/or output of transaction requests and/or responses. As such, the service provider computer 102 may include any number of computing devices, such as a PC, a digital assistant, a PDA, a smart phone, a digital tablet, an Internet appliance, an application-specific circuit, a microcontroller, a minicomputer, or any other processor-based device. The execution of suitable computer-implemented instructions or computer-executable instructions by the service provider computer 102 may form a special purpose computer or other particular machine that is operable to facilitate the processing of commands and/or the processing and output of transaction requests and/or responses.

With further reference to FIG. 1, each service provider computer 102 may include one or more processors 114, one or more memory devices 116, one or more transceivers and/or network interfaces 118, and/or one or more input/output (“I/O”) interfaces 120. The processors 114 may be configured to execute any number of software applications and/or computer-readable or computer-executable instructions. The memory devices 116 may include any number of suitable memory devices, such as caches, read-only memory devices, random access memory devices, flash memory devices, magnetic storage devices, removable storage devices (e.g., memory cards, etc.), etc. The memory devices 116 may include internal memory devices and/or external memory devices in communication with the service provider computer 102. The memory devices 116 may store data, executable instructions, and/or various program modules utilized by the processors 114. Examples of data that may be stored by the memory devices 116 include funding source and/or other tables 122, and/or any number of suitable program modules that may be executed by the processors 114, such as an operating system (“OS”) 124, and/or a payment delegate module 126.

The tables 122 stored in the memory 116 may include one or more funding source tables, logs, and/or databases for storing virtual wallet processing information. In some examples, a funding source table may store an index of funding sources. Additionally, in some instances, the funding source tables may be provided as part of a funding source application programming interface (“API”). In some examples, the funding source API may be provided by the mobile device 104 while in other examples, the funding source API may be provided by the service provider computers 110. Similarly, a funding source table may also allow a user 112 to create, change, remove, and/or view funding source information associated with the user 112. Further, the funding source tables, other tables, or databases may also store content management system (“CMS”) information, payment delegate indicators, authorization displays, authorization codes, and/or proxy transaction logs. In some examples, the tables 122 may be stored in one or more internal memory devices (e.g., internal hard drives, internal flash drives, etc.) of the service provider computer 102 and/or in one or more external memory devices accessible by the service provider computer 102.

The OS 124 may be a suitable software module that controls the general operation of the service provider computer 102. The OS 124 may also facilitate the execution of other software modules, for example, the payment delegate module 126. In some aspects, the payment delegate module 126 may be a suitable software module that facilitates the processing of transactions that utilize a payment delegate on behalf of a user. In operation, the payment delegate module 126 may receive a message from a merchant computing device 106 regarding a potential transaction. In certain embodiments, a message may be received via one or more suitable network communications. For example, a user 112 may utilize a suitable mobile device 104 (e.g., a smart phone, a personal computer, etc.) to access a Web-based application hosted by the service provider computer 102, and the user may request, via the Web-based application, that a transaction be processed. However, in other examples, a user 112 may utilize the mobile device 104 to provide virtual wallet functionality to a merchant computer 106, such as a POS device.

The service provider computer 102 may then process the message by, among other things, determining if the payment instrument associated with the message is a payment delegate. Further, the processing may be based on the type of message received. For example, once it is determined whether the payment instrument is a payment delegate, the service provider computer 102 may then process the transaction differently based on whether the transaction is associated with a pre-authorization request, a settlement request, a forced post, or a return. In some instances, the service provider computer 102 may provide an indication to the merchant computer 106 that the payment instrument is not a payment delegate. However, in some instances, when the payment instrument is not a payment delegate, the service provider computer 102 may record that the payment instrument was not a payment delegate. That is, in some instances, for example during a settlement or a return, no response to the merchant computer 106 may be provided.

With continued reference to the service provider computer 102, the one or more I/O interfaces 120 may facilitate communication between the service provider computer 102 and one or more mobile devices 104, merchant computers 102, and/or funding account gateways 110. The one or more network interfaces 118 may facilitate connection of the service provider computer 102 to one or more suitable networks 108, such as content provider networks or broadband networks (e.g., a cable network or a satellite network) and/or local area networks (e.g., a Bluetooth-enabled network, a Wi-Fi enabled network, etc.). In this regard, the service provider computer 102 may receive a message for processing and output. Additionally, as desired, the service provider computer 102 may communicate with any number of user devices via one or more local area networks.

The mobile device 104 of FIG. 1 (e.g., a smart phone or the like) may be any suitable processor-driven device that facilitates the receipt, processing, and/or output of transaction requests and/or responses. As such, the mobile device 104 may include any number of computing devices, such as a PC, a digital assistant, a PDA, a digital tablet, an Internet appliance, an application-specific circuit, a microcontroller, a minicomputer, or any other processor-based device. The execution of suitable computer-implemented instructions or computer-executable instructions by the mobile device 104 may form a special purpose computer or other particular machine that is operable to facilitate the processing of commands and/or the processing and output of transaction requests and/or responses.

With further reference to FIG. 1, a mobile device 104 may include one or more processors 128, one or more memory devices 130, one or more transceivers and/or network interfaces 132, and/or one or more input/output (“I/O”) interfaces 134. The processors 114 may be configured to execute any number of software applications and/or computer-readable or computer-executable instructions. The memory devices 130 may include any number of suitable memory devices, such as caches, read-only memory devices, random access memory devices, flash memory devices, magnetic storage devices, removable storage devices (e.g., memory cards, etc.), etc. The memory devices 130 may include internal memory devices and/or external memory devices in communication with the mobile device 104. The memory devices 130 may store data, executable instructions, and/or various program modules utilized by the processors 128. Examples of data that may be stored by the memory devices 130 include funding source tables as described above, and/or any number of suitable program modules that may be executed by the processors 128, such as an operating system (“OS”) 142, and/or a wallet module 144.

As noted above, the tables stored in the memory 130 may include one or more funding source tables, logs, and/or databases for storing virtual wallet processing information. In some examples, a funding source table may store an index of funding sources. Additionally, in some instances, the funding source tables may be provided as part of a funding source API. In some examples, the funding source API may be provided by the mobile device 104 while in other examples, the funding source API may be provided by the service provider computers 110. Similarly, a funding source table may also allow a user 112 to create, change, remove, and/or view funding source information associated with the user 112. Further, the funding source tables, other tables, or databases may also store CMS information, payment delegate indicators, authorization displays, authorization codes, and/or proxy transaction logs.

The OS 142 may be a suitable software module that controls the general operation of the mobile device 104. The OS 142 may also facilitate the execution of other software modules, for example, the wallet module 144. In some aspects, the wallet module 144 may be a suitable software module that facilitates the storing, transmitting, and/or processing of virtual wallet transaction requests. In some instances, the wallet module 144 may be configured for handling transactions that utilize a payment delegate on behalf of a user. Further, the wallet module 144 may be configured as the virtual wallet software application noted above. In operation, the wallet module 144 may transmit a message to a merchant computing device 106 regarding a potential transaction. In certain embodiments, a message may be sent via one or more suitable network communications. For example, a user 112 may utilize the mobile device 104 to access a Web-based application hosted by the service provider computer 102, and the user may request, via the Web-based application, that a transaction be processed. The service provider computer 102 may then process the message.

With continued reference to the mobile device 104, the one or more I/O interfaces 134 may facilitate communication between the mobile device 104 and one or more service provider computers 102, merchant computers 102, and/or funding account gateways 110. The one or more network interfaces 132 may facilitate connection of the mobile device 104 to one or more suitable networks 108, such as content provider networks or broadband networks (e.g., a cable network or a satellite network) and/or local area networks (e.g., a Bluetooth-enabled network, a Wi-Fi enabled network, etc.). In this regard, the mobile device 104 may receive a message for processing and output. Additionally, as desired, the mobile device 104 may communicate with any number of other user devices via one or more local area networks.

Further, the merchant computers 106 and the funding account gateways 110 may also be any suitable processor-driven devices that facilitate the processing of virtual wallet transactions. As such, the merchant computers 106 and the funding account gateways 110 may include any number of computing devices, such as a PC, a digital assistant, a PDA, a digital tablet, an Internet appliance, an application-specific circuit, a microcontroller, a minicomputer, or any other processor-based device. The execution of suitable computer-implemented instructions or computer-executable instructions by the merchant computers 106 and the funding account gateways 110 may form special purpose computers or other particular machines that are operable to facilitate the disclosed features.

Communications between various components of the architecture 100 may be facilitated via any number of suitable networks 108, such as one or more content provider networks (e.g., a cable network, a satellite network, etc.) and/or other networks. The networks 108 may include any telecommunication and/or data networks, whether public, private, or a combination thereof, including but not limited to, a local area network, a wide area network, an intranet, the Internet, public switched telephone networks, satellite networks, cable networks, and/or any combination thereof. Further, the networks 108 may be wired and/or wireless.

It will be appreciated that the architecture 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1.

### Illustrative Processes

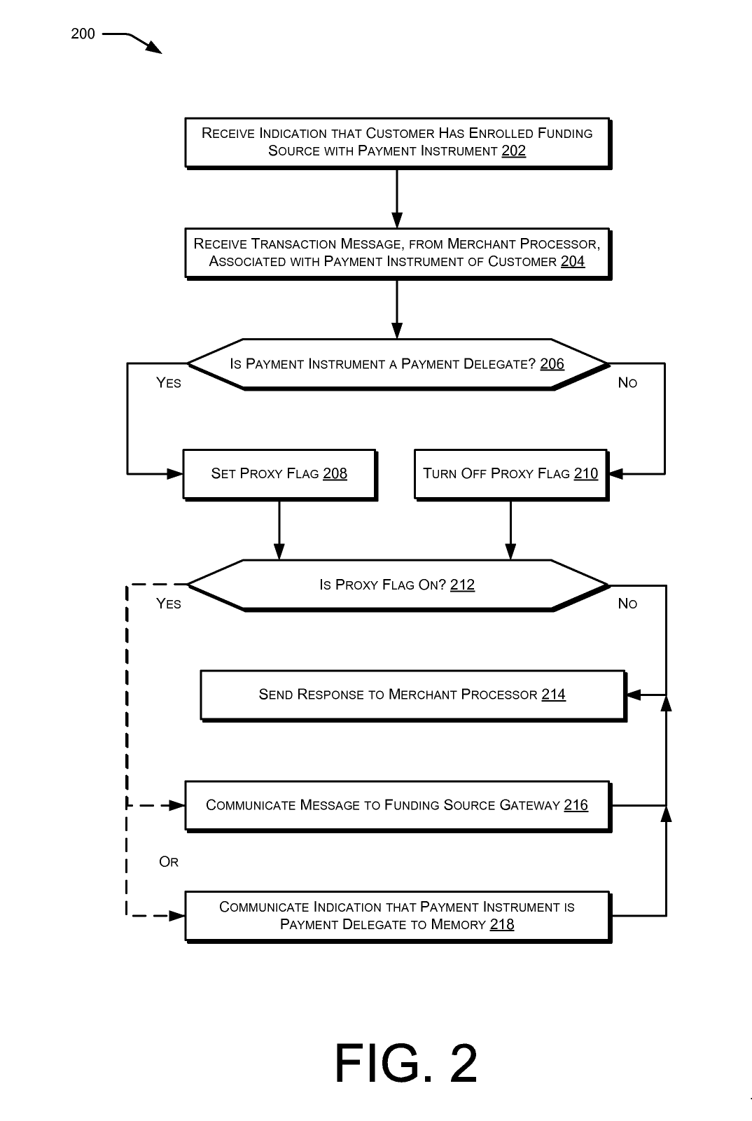

FIG. 2 illustrates a flow diagram of an example method 200 that may be performed by a computing device configured to process payment delegate transactions, such as the service provider computer 102 illustrated in FIG. 1. However, the method 200 may be performed by any number of suitable devices, such as a smart phone, a set-top box, a smart TV, a DVR, a PC, a laptop, a tablet computer, a PDA, any combination of the foregoing, or the like. In certain embodiments, the method 200 may be performed by a suitable payment delegate module associated with a service provider computer 102, such as the payment delegate module 126 illustrated in FIG. 1.

The method 200 may begin at block 202, where the method 200 may receive an indication that a customer has enrolled a funding source with a payment instrument. In some examples, the indication may be in response to the customer, such as user 112, enrolling a credit card with the service provider computer 102 and/or via the funding account gateway 110. Additionally, in some aspects, the credit card may be coupled to a pre-paid debit card to form a payment delegate. At block 204, the method 200 may receive a transaction message, from a merchant processor, such as the merchant computer 106 of FIG. 1. The transaction message may be associated with a payment instrument of the customer 112, such as the payment delegate.

At block 206, the method 200 may determine whether the payment instrument associated with the transaction request is a payment delegate. In some instances, determining that the payment instrument is a payment delegate includes searching the tables 122 in the memory 116 of the service provider computer 102. Alternatively, or in addition, other tables, look-ups, indices, or other data structures may be referenced to determine if the payment instrument is a payment delegate. If the method 200 determines that the payment instrument is a payment delegate, the method 200 may set a proxy flag at block 208. In some examples, setting the proxy flag includes switching a bit to “1” in a field or as part of a header of data associated with the transaction message and/or the payment instrument. Alternatively, if the method 200 determines that the payment instrument is not a payment delegate, the method 200 may un-set, set the bit to “0,” or otherwise turn off the proxy flag at block 210.

At block 212, the method 200 may determine if the proxy flag is on. As noted above, in some instances, a “1” indicates that the proxy flag is on, while a “0” indicates that the proxy flag is off. However, as desired, the opposite may be true, or the proxy flag may a combination of bits that equates to “on” and/or a combination of bits that equates to “off.” Either way, in some instances, the method 200 may end by sending a transaction response to the one or more merchant processors 106 at block 214 when the proxy flag is off. Alternatively, in some aspects, the method 200 may communicate the message to a funding source gateway 110 at block 216 or it may communicate, to a memory device, an indication that the payment instrument is a payment delegate at block 218 when the payment delegate flag is on. In either case, the method 200 may then end by sending the response to the merchant processor at block 214.

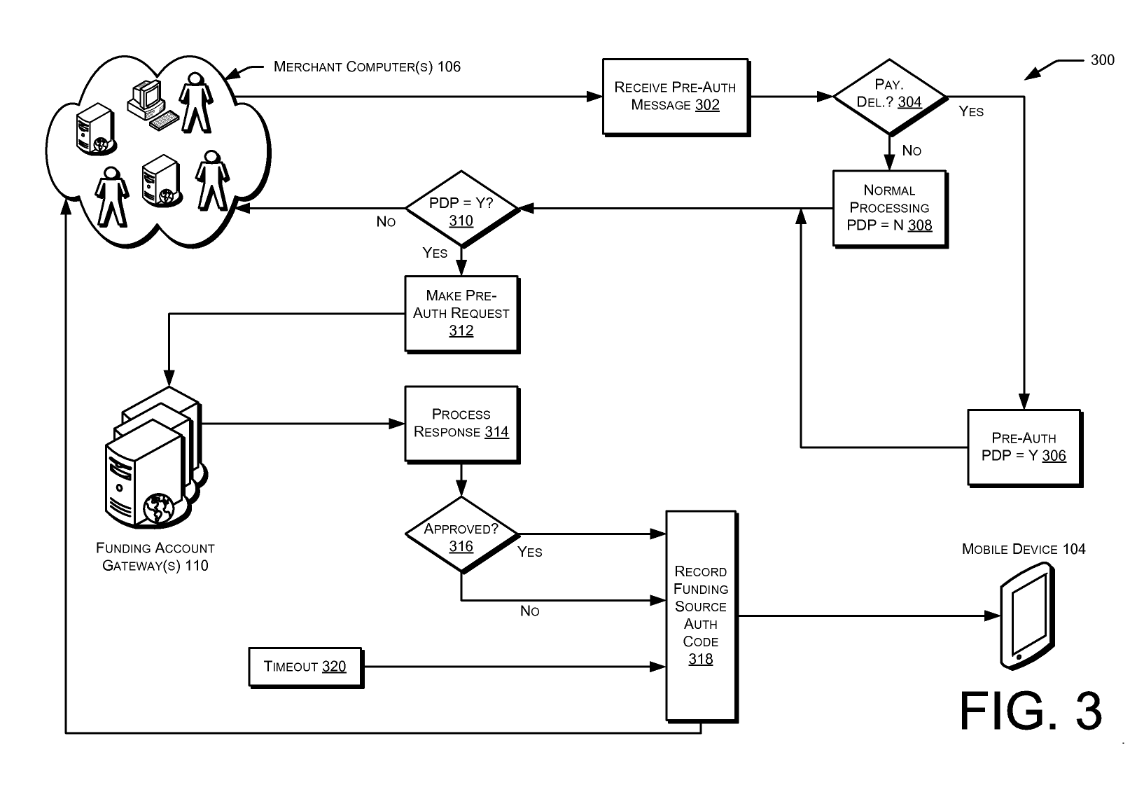

FIG. 3 illustrates a flow diagram of an example method 300 that may be performed by a computing device configured to process payment delegate transactions, such as the service provider computer 102 illustrated in FIG. 1. However, as noted above, the method 300 may be performed by any number of suitable devices, such as a smart phone, a set-top box, a smart TV, a DVR, a PC, a laptop, a tablet computer, a PDA, any combination of the foregoing, or the like. In certain embodiments, the method 300 may be performed by a suitable payment delegate module associated with a service provider computer 102, such as the payment delegate module 126 illustrated in FIG. 1. Additionally, the method 300 may, more specifically, be configured to process a pre-authorization message from one or more merchant computers 106 or a mobile device 104 of a user.

The method 300 may begin at block 302, where the method 300 may receive a pre-authorization message. In some instances, this message may be provided any time there is a purchase request without a card error, account error, or amount error. As noted above, in some instances, a pre-authorization message will be processed in order to determine if the potential purchaser (i.e., the holder of the payment instrument) has sufficient funds associated with the payment instrument to purchase a specific item. This may be based on the price of the item or any purchase/credit restrictions implemented by the merchant and/or the payment instrument. At block 304, the method 300 may determine whether the payment instrument associated with the customer and/or virtual wallet is a payment delegate. If the payment instrument is a payment delegate, the method 300, at block 306, may indicate that the requested transaction type is a pre-authorization and may set the payment delegate flag (e.g., “PDP=Y,” where “PDP” stands for “Payment Delegate Processing”). Alternatively, if the payment instrument is not a payment delegate (e.g., the payment instrument is a credit or debit card not coupled to another payment instrument), the method 300 may indicate that normal processing may be implemented by the merchant computer 106 and/or the method 300, and may turn off the payment delegate flag (e.g., “PDP=N”) at block 308.

At block 310, the method 300 may check the payment delegate flag and determine whether PDP=Y. If PDP≠Y (i.e., PDP=N), the method 300 may transmit the processed message back to the merchant computers 106 indicating that normal processing should be implemented for the pre-authorization. On the other hand, if PDP=Y at block 310, the method 300 may make a pre-authorization request to a funding account gateway, such as the one or more funding account gateways 110 at block 312. In some aspects, the funding source gateway 110 may be configured to determine whether a credit card account coupled to the users account (e.g., the account that the user may have registered with the virtual wallet application) has sufficient funds for the transaction. In response to the pre-authorization request made to the funding account gateway 110, the method 300 may receive and process a response from the gateway 110 at block 314.

In some instances, at block 316, the method 300 may determine whether the received and/or processed response from the funding account gateway 110 indicates that the pre-authorization request was approved. If the funding source was approved at block 316, the method 300 may post a hold for the pre-authorized amount on the funding source at block 318. Additionally, the method 300 may record the funding source authorization code with the mobile device 104 at block 318. On the other hand, if the method 300 determines, at block 316, that the pre-authorization was denied, the method 300 may record the funding source authorization code with the mobile device 104 at block 318. Alternatively, in some instances, the funding account gateway 110 may not provide a response in time. That is, a predefined time threshold may be set and, if the gateway 110 does not respond to the pre-authorization request from block 312 within that threshold, a “timeout” may occur at block 320. In this case, the method 300 may process the timeout as if a pre-authorization was denied at block 318. In any event, the method 300 may end after block 318 by sending a response, either that the pre-authorization was accepted, that the pre-authorization was denied, or that a timeout occurred, to the merchant computers 106. Additionally, in some instances, based on a pre-authorization being accepted, the method 300 may post a hold for the transaction amount with the funding source and/or the payment instrument.

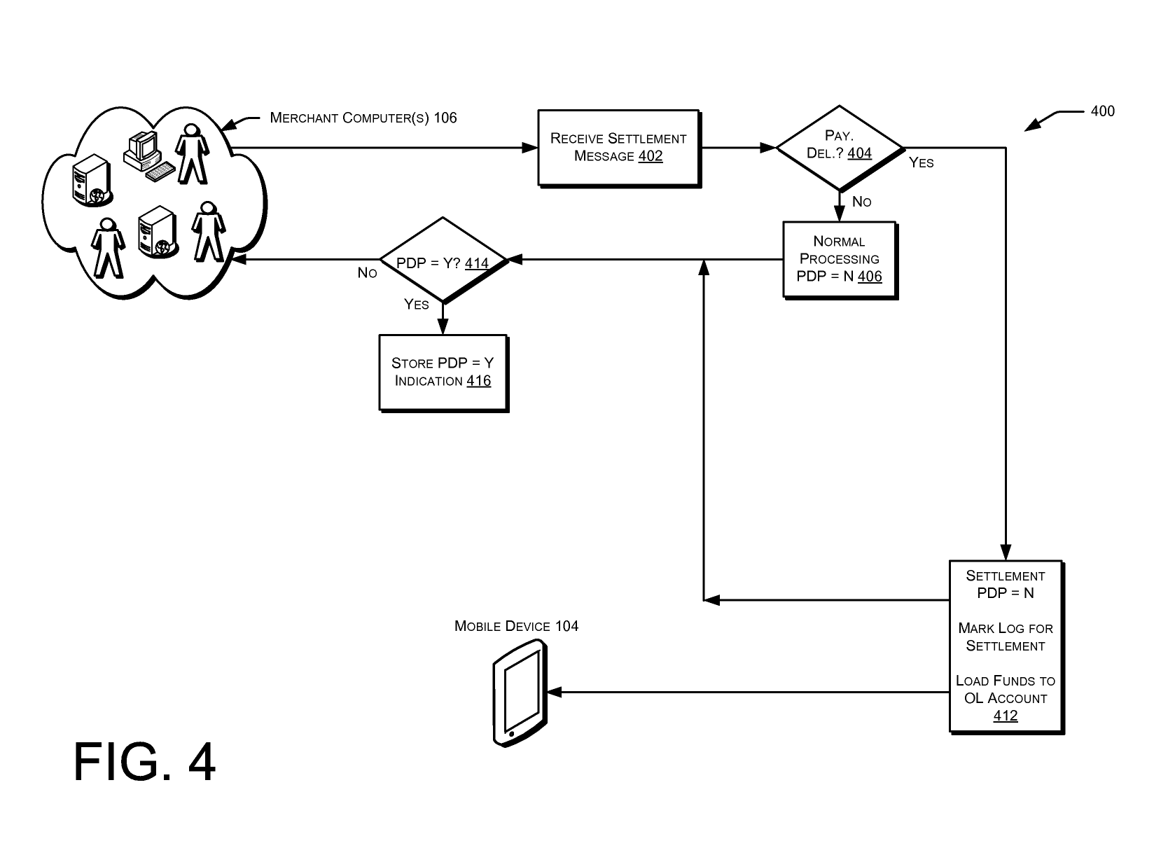

FIG. 4 illustrates a flow diagram of an example method 400 that may be performed by a computing device configured to process payment delegate transactions, such as the service provider computer 102 illustrated in FIG. 1. However, as noted above, the method 400 may be performed by any number of suitable devices, such as a smart phone, a set-top box, a smart TV, a DVR, a PC, a laptop, a tablet computer, a PDA, any combination of the foregoing, or the like. In certain embodiments, the method 400 may be performed by a suitable payment delegate module associated with a service provider computer 102, such as the payment delegate module 126 illustrated in FIG. 1. Additionally, the method 400 may, more specifically, be configured to process a settlement message from one or more merchant computers 106 or a mobile device 104 of a user.

The method 400 may begin at block 402, where the method 400 may receive a settlement message. In some instances, this message may be provided once a pre-authorization has been approved and once the merchant has tendered an item or service to the user. In other words, the method 400 may generally be, but is not limited to being, for posting a settlement record for the transaction after the transaction takes place and/or for funding an online account (e.g., the virtual wallet account coupled with the user's registered credit card) for the settled amount. In some instances, at block 404, the method 400 may determine if the payment instrument is a payment delegate. If the payment instrument is not determined to be a payment delegate (e.g., the payment instrument is a credit card), the method 400 may indicate that normal processing should be implemented and the method 400 may turn off the payment delegate flag (e.g., “PDP=N”) at block 406. Alternatively, if the payment instrument is a payment delegate, the method 400 may indicate that a log associated with a funding account gateway and/or the mobile device 104 should be marked for settlement at block 412. Additionally, at block 412, the method 400 may load funds to an online account to pay the merchant for the transaction and turn off the payment delegate flag (e.g., “PDP=N”). At block 414, the method 400 may determine whether PDP=Y. If PDP≠Y (i.e., PDP=N), the method 400 may transmit the processed message back to the merchant computers 106 indicating that normal processing should be implemented for the settlement. On the other hand, if PDP=Y at block 414, the method 400 may end by storing an indication that PDP=Y in memory at block 416.

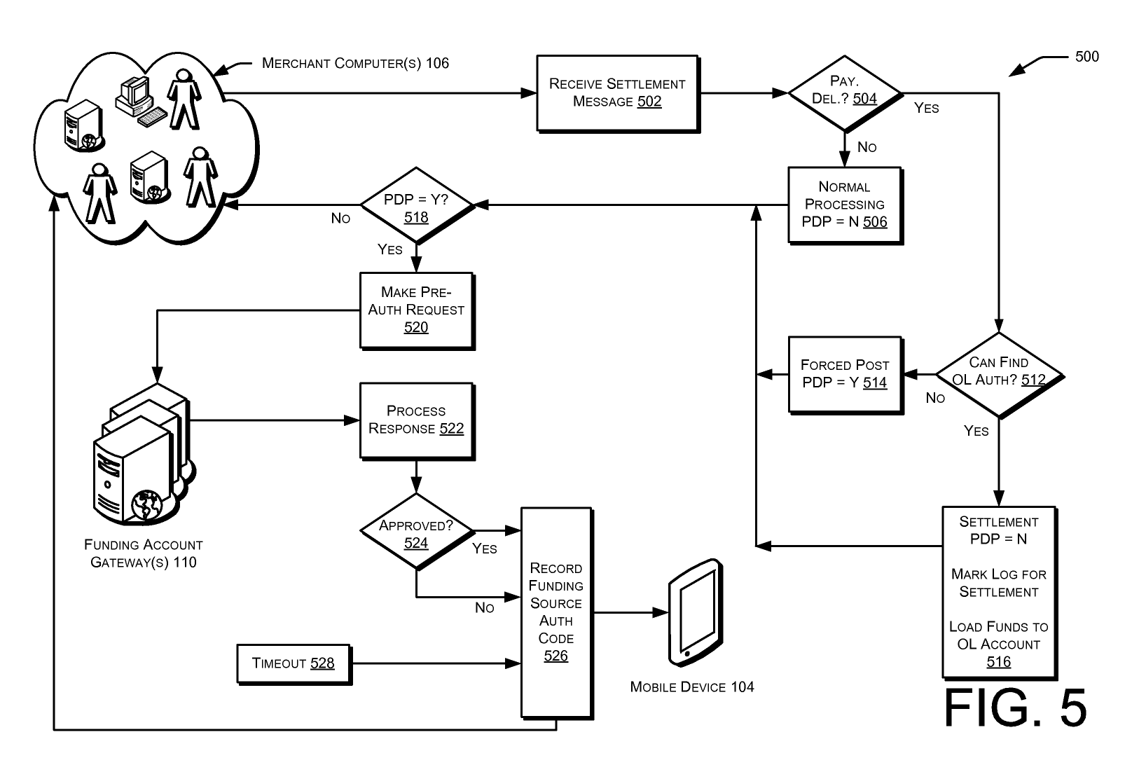

FIG. 5 illustrates a flow diagram of an example method 500 that may be performed by a computing device configured to process payment delegate transactions, such as the service provider computer 102 illustrated in FIG. 1. However, as noted above, the method 500 may be performed by any number of suitable devices, such as a smart phone, a set-top box, a smart TV, a DVR, a PC, a laptop, a tablet computer, a PDA, any combination of the foregoing, or the like. In certain embodiments, the method 500 may be performed by a suitable payment delegate module associated with a service provider computer 102, such as the payment delegate module 126 illustrated in FIG. 1. Additionally, the method 500 may, more specifically, be configured to process a forced post message from one or more merchant computers 106 or a mobile device 104 of a user.

The method 500 may begin at block 502, where the method 500 may receive a forced post message. In some instances, this message may be provided once a pre-authorization has been denied and once the merchant has tendered an item or service to the user. In other words, the method 500 may generally be, but is not limited to being, for forcing a settlement record for the transaction after the transaction takes place and/or for the forcing of funding an online account (e.g., the virtual wallet account coupled with the user's registered credit card) for a settled amount without pre-authorization that the funding source has sufficient funds. In some instances, at block 504, the method 500 may determine if the payment instrument is a payment delegate. If the payment instrument is not determined to be a payment delegate (e.g., the payment instrument is a credit card), the method 500 may indicate that normal processing should be implemented and the method 500 may turn off the payment delegate flag (e.g., “PDP=N”).

Alternatively, if the payment instrument is a payment delegate, the method 500 may determine whether an online authorization can be found at block 512. In some instances, determining whether a online authorization can be found at block 512 includes searching one or more memory locations and/or databases for a pre-authorization. In this example, the method 500 is performing a forced post; therefore, no pre-authorization was approved. Thus, the method 500 may continue to block 514, where the method 500 may indicate that the transaction is a forced post and the method 500 may set the payment delegate flag (e.g., “PDP=Y). On the other hand, if an online authorization was found (i.e., the transaction was not a forced post transaction) the method 500 may continue to block 516, much like in the method 400, prior to block 518. At block 518, the method 500 may determine whether PDP=Y. If PDP≠Y (i.e., PDP=N), the method 500 may transmit the processed message back to the merchant computers 106 indicating that normal processing should be implemented for the forced post. On the other hand, if PDP=Y at block 518, the method 500 may make a pre-authorization request to the funding account gateways 110 at block 520. As noted above with reference to FIG. 3, in some instances, the funding source gateway 110 may be configured to determine whether a credit card or debit account coupled to the users account (e.g., the account that the user may have registered with the virtual wallet application) has sufficient funds for the transaction. In response to the pre-authorization request made to the funding account gateway 110, the method 500 may receive and process a response from the gateway 110 at block 522.

In some instances, at block 524, the method 500 may determine whether the received and/or processed response from the funding account gateway 110 indicates that the pre-authorization request was approved. If the funding source was approved at block 524, the method 500 may post a hold for the pre-authorized amount on the funding source and, if successful, post a settlement transaction at block 526. Additionally, the method 500 may record the funding source authorization code with the mobile device 104 at block 526. On the other hand, if the method 500 determines, at block 524, that the pre-authorization was denied, the method 500 may record the funding source authorization code with the mobile device 104 at block 526. Alternatively, in some instances, the funding account gateway 110 may not provide a response in time. That is, a predefined time threshold may be set and, if the gateway 110 does not respond to the pre-authorization request from block 520 within that threshold, a “timeout” may occur at block 528. In this case, the method 500 may process the timeout as if a pre-authorization was denied at block 524. In any event, the method 500 may end after block 526 by sending a response, either pre-authorization accepted, pre-authorization denied, or transaction timed-out, to the merchant computers 106. Additionally, in some instances, based on a pre-authorization being accepted, the method 500 may post a hold for the forced post amount with the funding source and/or the payment instrument and/or mark a log associated with the funding account gateways 110 to submit a settlement transaction for the forced post amount on the funding source; thus, canceling the hold. Further, the method 500 may also post a spend of the settled amount to an online account associated with the mobile device 104 and/or the virtual wallet, and the method 500 may fund the online account for the settled amount. Alternatively, when the pre-authorization is denied and/or a timeout occurs, the method 500 may post a spend of the settled amount to the online account; thus, driving the account to negative and/or the method 500 may turn off payment delegate functionality altogether.

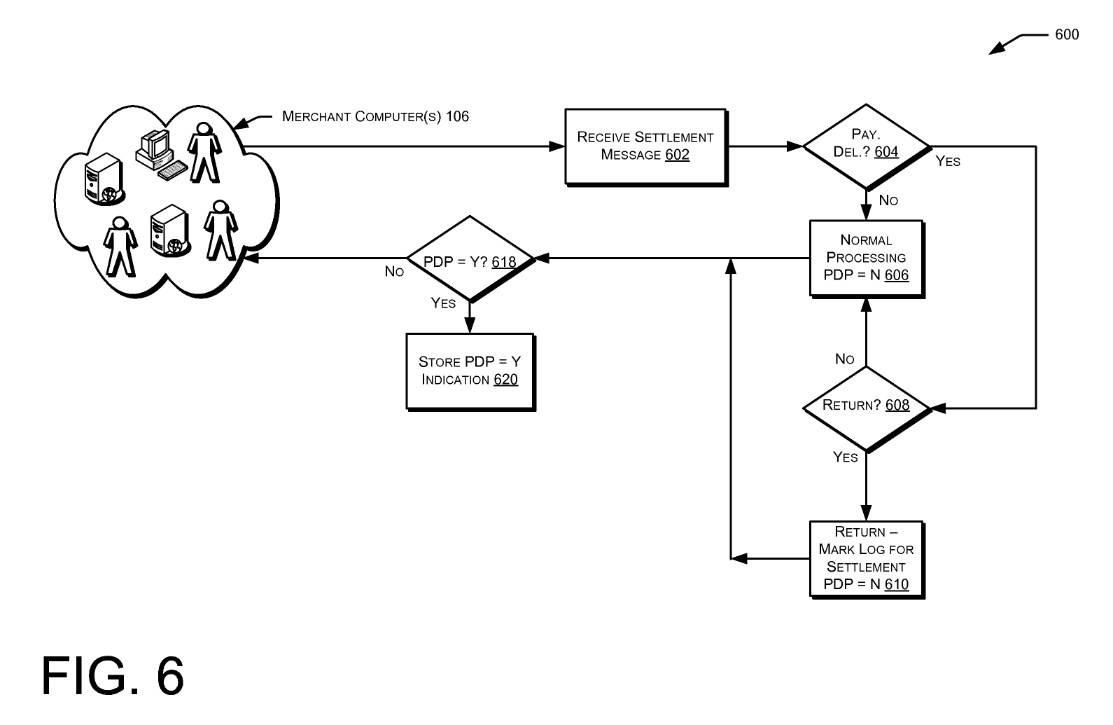

FIG. 6 illustrates a flow diagram of an example method 600 that may be performed by a computing device configured to process payment delegate transactions, such as the service provider computer 102 illustrated in FIG. 1. However, as noted above, the method 600 may be performed by any number of suitable devices, such as a smart phone, a set-top box, a smart TV, a DVR, a PC, a laptop, a tablet computer, a PDA, any combination of the foregoing, or the like. In certain embodiments, the method 600 may be performed by a suitable payment delegate module associated with a service provider computer 102, such as the payment delegate module 126 illustrated in FIG. 1. Additionally, the method 600 may, more specifically, be configured to process a return message from one or more merchant computers 106 or a mobile device 104 of a user.

The method 600 may begin at block 602, where the method 600 may receive a return message. In some instances, this message may be provided once a return has been requested by the user and/or the merchant. In other words, the method 600 may generally be configured to, but is not limited to, providing a refund of a settled amount to a funding account used in the preceding purchase. In some instances, at block 604, the method 600 may determine if the payment instrument is a payment delegate. If the payment instrument is not determined to be a payment delegate (e.g., the payment instrument is a credit card), the method 600 may indicate that normal processing should be implemented and the method 600 may turn off the payment delegate flag (e.g., “PDP=N”) at block 606. Alternatively, if the payment instrument is a payment delegate, the method 600 determine, at block 608, whether the transaction is for a return. If not, the method 600 may proceed block 606. On the other hand, if the transaction is a return, as determined at block 608, the method 600 may indicate that the message is a return, mark a log associated with a funding account gateway and/or a user that a settlement should occur, and/or post a credit of the settled amount to the funding source at block 610. Additionally, the method 600 may post a credit and/or a debit of the settled amount to an online account associated with the user and turn off the payment delegate flag (e.g., “PDP=N”) at block 610.

At block 618, the method 600 may determine whether PDP=Y. If PDP≠Y (i.e., PDP=N), the method 600 may transmit the processed message back to the merchant computers 106 indicating that normal processing should be implemented for the return. On the other hand, if PDP=Y at block 618, the method 600 may end by storing an indication that PDP=Y in memory at block 620.

The operations described and shown in the methods 200-600 of FIGS. 2-6 may be carried out or performed in any suitable order as desired in various embodiments of the disclosure. Additionally, in certain embodiments, at least a portion of the operations may be carried out in parallel. Furthermore, in certain embodiments, less than or more than the operations described in FIGS. 2-6 may be performed.

Various block and/or flow diagrams of systems, methods, apparatus, and/or computer program products according to example embodiments of the disclosure are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Many modifications and other embodiments set forth herein will be apparent having the benefit of the teachings presented in the foregoing descriptions and the associated drawings. Therefore, it is to be understood that the concepts described herein are not to be limited to the specific embodiments disclosed and that modifications and other embodiments are intended to be included within the scope of the appended claims. Although specific terms are employed herein, they are used in a generic and descriptive sense only and not for purposes of limitation.

### CONCLUSION

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

1. A method, comprising:
receiving, by at least one communication interface of a payment processing service from a merchant processor, a transaction message associated with a payment instrument of a customer;
determining, by at least one processor, when the payment instrument is a payment delegate; and
communicating, by the at least one communication interface, a response to the merchant processor when the payment instrument is not a payment delegate; or
communicating, by the at least one communication interface, at least one of a message to a funding source gateway or an indication that the payment instrument is a payment delegate to at least one memory when the payment instrument is a payment delegate.

2. The method of claim 0, further comprising determining when the customer has enrolled a funding source with the payment instrument.

3. The method of claim 0, wherein the merchant processor is associated with a point of sale device processor.

4. The method of claim 0, wherein the payment instrument comprises a decoupled payment instrument.

5. The method of claim 4, wherein the decoupled payment instrument comprises a credit account linked to a prepaid debit account.

6. The method of claim 0, further comprising setting a payment delegate flag within the message to indicate when the payment instrument is a payment delegate.

7. The method of claim 0, wherein determining when the payment instrument is a payment delegate comprises comparing an identifier associated with the payment instrument against a funding source table.

8. The method of claim 0, wherein the transaction message comprises a pre-authorization message, a settlement message, a forced post message, or a return message.

9. The method of claim 8, further comprising determining when the transaction message comprises the pre-authorization message, the settlement message, the forced post message, or the return message.

10. The method of claim 0, wherein communicating the message to the funding source gateway when the payment instrument is a payment delegate comprises communicating a pre-authorization request to the funding source gateway for approval of a funds from a funding source when the transaction message comprises the pre-authorization message or the forced post message.

11. The method of claim 10, further comprising, when the transaction message comprises the pre-authorization message:
receiving, by the at least one communication interface, a response from the funding source gateway;
determining, by the at least one processor, when the response indicates (i) that the pre-authorization request was approved, (ii) that the pre-authorization request was denied, or (iii) that a timeout occurred;
posting a hold for an amount associated with the pre-authorization request on the funding source when the response indicates that the pre-authorization request was approved;
recording a pre-authorization approval and an authorization code associated with the funding source in the at least one memory when the response indicates that the pre-authorization record was approved; and
communicating the pre-authorization approval to the merchant processor.

12. The method of claim 10, further comprising, when the transaction message comprises the settlement message:
recording a settlement in a log associated with the funding source; and
loading funds to an online account.

13. The method of claim 10, further comprising, when the transaction message comprises the forced post message:
receiving, by the at least one communication interface, a response from the funding source gateway;
determining, by the at least one processor, when the response indicates (i) that the pre-authorization request was approved, (ii) that the pre-authorization request was denied, or (iii) that a timeout occurred;
when the response indicates that the pre-authorization request was approved: (i) posting a hold for an amount associated with the pre-authorization request on the funding source, (ii) recording an indication to submit a settlement transaction for an amount associated with the forced post on the funding source, wherein the indication is recorded in a log associated with the funding account, and (iii) canceling the hold for the amount associated with the pre-authorization request; and
communicating the pre-authorization approval to the merchant processor.

14. The method of claim 10, further comprising posting a credit for an amount associated with the transaction when the transaction message comprises the return message.

15. A system, comprising:
at least one memory configured to store computer-executable instructions; and
at least one processor configured to access the at least one memory and execute the computer-executable instructions to:
receive, by at least one communication interface, an indication that a customer has enrolled a funding source with a payment instrument;
receive, from a merchant processor, a pre-authorization message associated with the payment instrument of the customer;
determine, by the at least one processor, when the payment instrument is a payment delegate;
communicate a response to the merchant processor when the payment instrument is not a payment delegate; and
when the payment instrument is a payment delegate, communicate a pre-authorization request to a funding source gateway for approval of a funds from a funding source.

16. The system of claim 15, wherein the payment instrument comprises a decoupled payment instrument comprising a credit account linked to a prepaid debit account.

17. The system of claim 15, wherein the at least one processor is further configured to execute the computer-executable instructions to:
receive a response from the funding source gateway;
determine when the response indicates (i) that the pre-authorization request was approved, (ii) that the pre-authorization request was denied, or (iii) that a timeout occurred;
post a hold for an amount associated with the pre-authorization request on the funding source and record a pre-authorization approval including an authorization code associated with the funding source in the at least one memory when the response indicates that the pre-authorization record was approved; and
communicate the pre-authorization approval to the merchant processor.

18. One or more computer-readable media storing computer-executable instructions for processing virtual wallet transactions that, when executed by at least one processor, configure the at least one processor to perform operations comprising:
receiving an indication that a customer has enrolled a funding source with a payment instrument;
receiving, from a merchant processor, a settlement message associated with the payment instrument of the customer;
determining whether the payment instrument is a payment delegate;
communicating a response to the merchant processor if the payment instrument is not a payment delegate; and
if the payment instrument is a payment delegate:
recording a settlement in a log associated with the funding source; and
loading funds to an online account.

19. The one or more computer-readable media of claim 18, further comprising setting a payment delegate flag within the settlement message to indicate when the payment instrument is a payment delegate.

20. The one or more computer-readable media of claim 18, wherein the payment instrument comprises a decoupled payment instrument comprising a credit account linked to a prepaid debit account.
